(19) United States
(12) Patent Application Publication
(10) Pub. No.: US 2015/0153265 A1
(43) Pub. Date: Jun. 4, 2015

(54) ANNULAR FLOW ELECTROCHEMICAL CELL FOR MEASUREMENTS ONLINE

(71) Applicant: Centro para la Investigación Científico Tecnológico para la Minería CICITEM, Antofagasta (CL)

(72) Inventor: Luis Reynaldo CACERES VILLANUEVA, Antofagasta (CL)

(21) Appl. No.: 14/548,973

(22) Filed: Nov. 20, 2014

(30) Foreign Application Priority Data
Nov. 21, 2013 (CL) 2013-03352

(51) Int. Cl. G01N 17/02

(52) U.S. Cl. CPC G01N 17/02

(57) ABSTRACT

System for performing online electrochemical measurements with solid conductors such as metals and minerals immersed in a specific electrolyte comprising an annular flow cell (1), a dosing pump (2) preferably a centrifuge pump driven by a frequency variator, a potentiostat (3), valves (V1 and V2), a rotameter or flowmeter (4), a solution, liquid, fluid, electrolyte fluid, or solution (5) supply which can come from a pope or process tank, and an electrolyte flow or circulation fluid (6), which is applied among other for measuring the steel corrosion and measuring equilibrium potentials in flotation processes, with clear advantages over known systems due to the flow cell design presents great versatility in terms of size, flow, fast replacement of working and reference electrodes, stability of measurements and with the alternative to be used for powdered electro active solids, such as in the case of mineral concentrates.

### FIELD OF THE INVENTION

The present invention is related to metal treatment and mineral processing industry, particularly with an instrumental system for performing on line electrochemical measurements of solid conductors in contact with electrolytes circulating in continuous flow, and is particularly applicable to monitoring metal corrosion and characterization of flotation processes.

### BACKGROUND OF THE INVENTION

There is a variety of instruments designed to measure operating conditions such as temperature, pressure, level, fluid flow, among others in the industry. For these cases, devices with specific surfaces or geometry for detecting some property related to the parameter to be measured are used. For example temperature sensors called thermocouples are formed by the union of two different metals. In the binding surface of these metals occurs a voltage variation which is a function of temperature. So by direct measurement of this voltage, the temperature surrounding it is accurately inferred.

In the case of mechanical stress related parameters such as pressure, torque, etc., sensors which are called piezometers are used which accurately detect the deformation of an element (string or wire); this detection is performed in terms of frequency of vibration which is specific for each stress level at which the string is subjected.

Other sensors use variations in magnetic fields or other property related to the parameter to be measured. Measuring a property associated with a flow of fluid flowing through a conduit by a sensor (online measuring) must meet several requirements that are: rapid response, insensitivity to fluid flow turbulence, no reactivity with flow components, insensitivity to variations in electric fields and mechanical strength.

One of the more difficult online measurements is determining electrochemical potentials. This is because their measurement is affected by the following factors: a) complexity of measurement components: requires two or three electrodes electrically isolated from each other, b) geometry of the surface, c) sensitivity to fluid turbulence, d) alteration of surface morphology during measurement e) specificity of each particular system. This last point concerns the required material for each of the measuring electrodes, in particular the so-called working electrode that in some cases must be made from powder material.

The standard methodology for electrochemical measurements consists in the use of three electrodes immersed in stationary fluid. During measurement usually significant changes in the surface of the working electrode occur due to interface reactions. This design cannot be applied for online measurement fluids.

The simplest electrochemical measurements are for electrodes in balance. The best known case refers to the measurement of oxidation reduction potentials. For this purpose a platinum and a reference electrode is used. The current involved in this measurement is very low so that the durability of the sensor is prolonged.

For electrochemical measurements with electrodes to which a programmed electrical signal either potential or current is applied a variety of techniques have been developed. Between the ones of programmed potential, such as chronoamperometry, pulse voltammetry, square wave voltammetry, sweep voltammetry and cyclic voltammetry, the current response to predetermined time intervals is recorded. In programmed current techniques, such as constant current chronopotentiometry, variable current chronopotentiometry, and cyclic chronopotentiometry the potential at predetermined time intervals is recorded. All these techniques are applied to electrochemical processes in various situations.

Electrochemical cells commonly used and that have been developed so far are described in a variety of books and articles. Relevant descriptions are found in the following references:
Encyclopedia of electrochemistry, volume 3, Instrumentation and electroanalytical chemistry, chapter 2.4 Hydrodynamics electrodes; Allen J. Bard (Editor), Martin Stratmann (Editor); Patrick R. Unwin (Editor), ISBN 978-3-527-30395-3—Wiley-VCH, Weinheim, pp 134-159, 2003;
Electrochemistry, Principles, Methods and Applications, Chapter 8, Hydrodynamic electrodes; Christopher M. A. Brett, Ana Maria Oliveira Brett, Oxford University Press, Oxford, England, pp. 151-173, 1994;
Handbook of Electrochemistry, Chapter 2, Practical Electrochemical cells; Cynthia G. Zoski, Elsevier Amsterdam, England, pp. 33-56, 2007.

Electrochemical measurements are conducted in two types of cells, cells with electrolyte confined to a cell without agitation with static working electrodes and hydrodynamic cells in which the fluid is moving relative to the working electrode.

The cell of the present invention corresponds to the type of hydrodynamic cell in which fluid flows tangentially to the working electrode that is fixed. There are a variety of designs for these conditions, each applicable to specific situation and with operating restrictions.

Particular aspects of the new design of flow cell are low cost, use for online measurement, stability, ease of installation, and ease and speed for the replacement of the working electrode, which is particularly useful for corrosion, where the surface degrades over time.

### STATE OF THE ART

The hydrodynamic cells available to date are:
Rotating electrode: this electrode is a disk that is bordered by a plastic sheath usually made of Teflon and rotating at a controlled speed that promotes a characteristic fluid movement around the disk surface. Fluid in a fixed volume is confined in a static tank without agitation. To this electrode, which is the most used, expressions applicable to different types of electrochemical tests have been developed.
Wall-duct electrode: in this case the electrode is fixed, with circular form, with a flow coming from a nozzle of larger diameter than the disc, so that the hydrodynamic regime is similar to the one of the rotating disk. The advantage of this electrode is that optical sensors can be incorporated to examine the surface of the working electrode.
Wall-jet electrode: this electrode has a configuration similar to the above but it differs in that the nozzle diameter is smaller than the one of the working electrode. This option has been shown to have high sensitivity due to the rapid mass transfer that occurs.
Electrode tube: a ring electrode is inserted into a larger diameter tube through which flows a fluid whose speed is adjusted to achieve laminar flow. This electrode has been used for research in reactions with release of radicals. The advantage of this electrode is that suitably choosing the dimensions of the electrode it is possible to achieve full conversion of the reactants.
Channel electrode: this rectangular surface electrode is printed on the wall of a conduit with rectangular section. The fluid velocity is controlled to achieve laminar regime: as in electrode tube it is possible to achieve full conversion of electro active species.

For annular geometry electrodes it has been created various designs described in scientific publications and patents. These exhibit marked differences in relation to the present invention.

Most important designs reported in publications are:

Annular duct formed by two concentric tubes where fluids flow through the inner tube so as through the annular space between the inner and outer tube. Both tubes are fixed and its purpose has been made heat transfer studies (this design is well known and is mentioned in many articles, for example, in G. Lu, J. Wang, Experimental investigation on flow characteristics in a narrow annulus, Heat Mass Transfer, Vol 44, 495-499, 2008).

The document of G. Weyns (Turbulent fluid flow and electrochemical mass transfer in an annular duct with an obstruction, G. Nelissen, J. G. A. Pembery, P. Macie, J. Deconinck, H. Deconinck, M. A. Patrick, y A. A. Wragg, J Appl Electrochem, Vol 39, 2453-2459, 2009) describes an annular duct formed by a nickel outer tube of 53 mm of internal radius and 4.5 m long, and an inner cylinder composed of nickel with 12 mm in diameter and 4.5 m long, it was used for mass transfer studies. In the internal tube 32 micro electrodes regularly spaced and electrically insulated were placed acting with cathodes to reduce ferricyanide to ferrocyanide and the anode was the outer tube. This system did not use reference electrode and for the electrical connections an insulated conductor wire of 0.2 mm diameter was used. No details of how the conductor wire is distributed to the current measuring instruments are given. The feed and outputs of solution were through elbows located at the ends of the tube.

Document JP2003130846 A discloses a method of simultaneous, rapid, highly sensitive and continuous concentration measurement of metals in a liquid stream for which a liquid metal electrode such as mercury is used. The measurement is based on analysis of voltammetry curves corresponding to the interaction between the surface of mercury and metals dissolved in the liquid being analyzed. In this device there is no solid metal specimen (steel or mineral) interacting with an electrolyte and thus it cannot be applied to the electrochemical characterization of corrosion or mineral flotation. It is only applicable for determining concentrations of metals that are dissolved in a liquid specimen. Consequently the document is not comparable to the cell of the proposed invention.

Document of Shoukry and Shemilt (Mass Transfer Enhancement in Swirling Annular Pipe Flow, Ehsan Shoukry, Leslie W. Shemilt; Ind. Eng. Chem. Process Des. Dev., 1985, 24 (1), pp 53-56) discloses a very long cell (2.5 m) without reference electrode, which cannot be used for online measurements due to its dimensions. The cell of the article cell has an outer stationary anode and several internal cathodes all in fixed positions not constructed to be removed and replaced during operation. Moreover these electrodes (anode and cathode) are made of the same material (nickel) and their design does not contemplate any electrode replacement. The design includes only fixed current measurement as limit currents. In addition due to the dimensions of the electrodes used currents are very high and therefore a high capacity and not portable potentiostat is required. The design of the article only covers measurement of currents in a specific electrolyte, as a solution of potassium ferricyanide (K₃Fe(CN)₆). It is not possible to use, for example, sea water or arbitrary solutions. Therefore, with the apparatus of the article it is not possible to perform measurements to characterize corrosion of metals; neither performing electrochemical studies of minerals in flotation processes. Finally in the design of the article, it is used a bypass with a throttle valve for controlling flow. In contrast, in the proposed invention a pump with frequency variator is used.

Document of C. F. Oduoza (Electrochemical mass transfer at a heated electrode in a vertical annular flow cell, Chemical Engineering and Processing, C. F. Oduoza, Vol 43, 921-928, 2004). The document discloses an electrochemical cell with annular flow designed with an intermediate zone of constant cross-section and a final zone wherein the cross-section gradually increases up to a maximum value. This design is directed to obtain a high electrolytic activity in the entry zone and low current density in regions wherein salt deposition is undesirable. This system does not use a reference electrode and no details are given on how the electrical connections were made. In an embodiment, the inner tube acted as a cathode to reduce ferricyanide to ferrocyanide and the anode was the external tube. The only technological application mentioned is related to the production of sodium hypochlorite for water purification. In that case, in the region with the greatest cross-section, deposition of calcium salts is unlikely.

U.S. Pat. No. 8,236,440 discloses an electrode denominated partial flow cell, formed by a cathode and an anode separated by a porous spacer, allowing the flow of active electro positive species between the anode and cathode. The system can be configured to have stationary active electro species or in a flow regime in the anode as well as in the cathode. This cell does not have a reference electrode and its purpose is to be used as an energy cell or a conversion reactor.

U.S. Pat. No. 6,952,013 discloses a flow cell including a module formed by a working electrode in the form of a porous medium, an electrolyte supply system, an outlet module with a counter electrode incorporated, and a power source connected to the working and counter electrodes. Applications are described in which a reference electrode, current measurement devices, and various power supply are adapted with the aim to be used in electrolysis and to provide an electric field of great intensity to create a spray-type flow towards the counter electrode. A specific application is as an instrument coupled to spectrometers.

U.S. Pat. No. 6,627,349 discloses improvements for an alkaline electrochemical cell to obtain a high rate service with an electrode design that can be easily assembled, comprising a deposit, a first electrode disposed in the deposit, a second electrode disposed in the deposit, a separator located between the first and second electrode and an electrolyte. The first electrode has a wall defining an interface surface. The second electrode includes an electrochemically active material piece with a cylindrical surface with multiple openings in the mantle. Although this invention is described as a primary alkaline cell it could also be used in other primary cells such as zinc-carbon, lithium cells, or rechargeable cells such as nickel-cadmium, metallic hydride nickel, or lithium ionic cells.

U.S. Pat. No. 7,927,731 discloses a redox flow cell, using a porous membrane separating a first half cell and a second half cell. The porous membrane is chosen according to porosity and specific width according to a method described in detail. The application of this invention is in continuous use batteries wherein the electrolyte can be replaced easily.

U.S. Pat. No. 8,211,291 discloses a device for electrochemical measurement having at least one electrode that can be heated through a heating current as an alternate current, and two connections for the heating current supply. The measuring device is connected through a third connection to the electrode with a bridge circuit which also connects the first and second connection. A method is also disclosed to perform electrochemical measurements at high temperatures. The sensing apparatus and method for electrochemical measurements allows measurements with low interferences due to heating with a simplified design for the electrodes.

### BRIEF DESCRIPTION OF FIGURES

FIG. 1 shows the system to perform electrochemical measurements on line. Its elements are: (1) annular flow cell; (2) dosing pump; (3) potentiostat; (4) rotameter or flowmeter; (5) solution supply (process tank or piping with a solution, liquid, fluid, electrolyte flow or fluid; (6) electrolyte fluid or fluid circulation; valve 1 (V1); valve 2 (V2); electrical connections represented as: counter-electrode (CE); reference electrode (RE); working electrode (WE).

FIG. 2 shows a schematic representation of the components of the annular flow cell. The modular parts of the flow cell are (7) cell body; in FIG. 2A; and (8) central axis of the cell, in FIG. 2B. FIG. 2C shows element (8) inserted in element (7) to form the flow cell for use.

FIG. 3 shows a scheme of the external body of the cell (7) with a front cross view (A), right and left profiles, top view and bottom view (B) and A-A′ cross view (C). FIG. 3B shows elements (9) connecting fitting of solution outlet; (10) fast coupling fitting; (11) reference electrode; (12) head; (13) tubular counter electrode of a noble metal; (14) connecting fitting to solution supply.

FIG. 4 shows the central axis of the cell (8) and its elements: (15) electrical connection stem; (16) top plastic support; (17) waterproof O ring seal; (18) annular band for working electrode; (19) bottom support; and (20) fixing stub.

FIG. 5 shows a cross section of the cell under working flow conditions. The fluid circulation is from the inlet in the top part, from there enters the annular space through four holes in radial direction indicated in the cut B-B′. The outlet flow is through the left top part. The space filled with fluid is emphasized in black. The electrical connections to the potentiostat are represented as: counter electrode (CE); reference electrode (RE); and working electrode (WE).

FIG. 6 shows the annular plastic band (18) to use measurements with sample in powdered form that is installed in the central axis (7), in the application for measurement of equilibrium potential in flotation processes. The hole in the mantle must be filled with a wax-graphite mixture.

FIG. 7 shows the experimental scheme used for measurement of polarization curves for carbon steel 1020 in a 0.1M NaCl electrolyte obtained by linear polarization scan through the use of the flow cell of the present invention for Example 1.

FIG. 8 shows dimensions of the flow cell used for polarization curves for carbon steel measurements in NaCl 0.1M solution of Example 1. (a) corresponds to 20 mm, (b) corresponds to 10 mm, (c) corresponds to 17 mm, (d) corresponds to 190 mm and (e) corresponds to 300 mm.

FIG. 9 shows the polarization curves obtained in Example 1 through linear sweep voltammetry measured with the annular cell with carbon steel in a solution of NaCl 0.1M with a sweep potential rate of 2 mV/s. The lower curve was obtained immediately after introducing the central axis with the specimen. Every half hour the measurement was repeated producing each time curves displaced upwards. The Re value for this measurement was 1200.

FIG. 10 shows comparison polarization curve of Example 1 obtained by linear scanning voltammetry measured with a rotary disc electrode with carbon steel in a solution of NaCl 0.1 M with a sweep potential rate of 2 mV/s. The electrolyte was confined in a deposit. The Re value for this measurement was 1500.

FIG. 11 shows polarization curve for a measurement with air of Example 2 obtained by linear sweep voltammetry measured in the flow cell with carbon steel in a solution of NaCl 0.1M with a sweep potential rate of 2 mV/s. Re value for this measurement was 5000 (caudal 210 L/h). The dotted line is a mathematical adjustment with a model to determine electrochemical parameters.

FIG. 12 shows polarization curve for measurement in anaerobic conditions (nitrogen bubbling) of Example 2 obtained by linear sweep voltammetry measured with annular cell with carbon steel in a solution of NaCl 0.1M with a sweep potential rate of 2 mV/s. The Re value for this measurement was 5000 (flow 210 L/h).

FIG. 13 shows the polarization curves for measurement obtained by linear sweep voltammetry at a sweep velocity rate of 2 mV/s for the wax-graphite electrode in 0.5 M NaCl bubbled in a flow cell of Example 3. The dotted line was obtained with the wax-graphite electrode in 0.5M NaCl with nitrogen bubbling. The line curve was obtained with wax-graphite-mineral electrode.

### BRIEF DESCRIPTION OF THE INVENTION

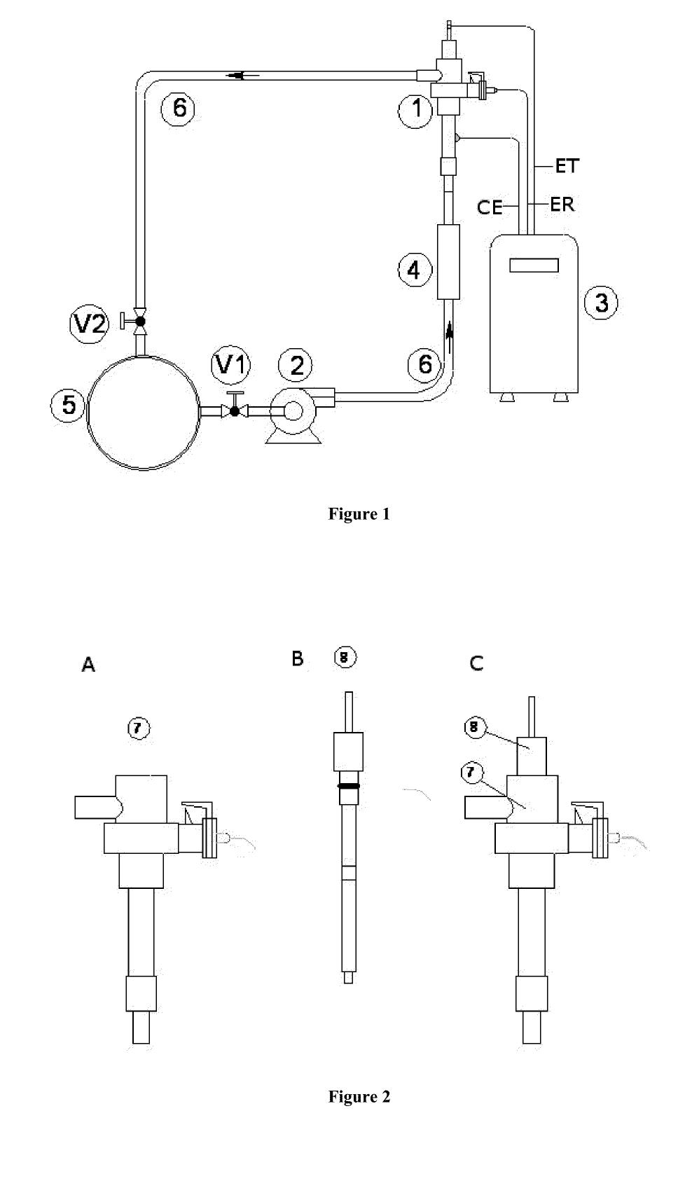

The present invention describes a system to perform electrochemical online measurements either for characterizing metallic surface corrosion in corrosive environments, or mineral flotation, consisting of a flow cell design presenting versatility advantages in terms of size, flow, quick working and reference electrodes replacement, measurement stability and use of powdered electroactive solids alternative use, such as the case of concentrated minerals. FIG. 1 shows a scheme of the system comprising a flow cell (1) with complementary accessories to maintain a predetermined and stable flow from a tank or pipe, with electrolyte flow of a continuous industrial process. The complementary accessories for the functioning of the cell are a centrifuge pump (2) driven by a frequency variator which controls rotation speed of the rotor to maintain a fluid (6) circulation at a stable flow, a flowmeter or rotameter (4), a supply (5) that can be a pipe or tank supplying electrolyte to an industrial process, valves V1 and V2 to isolate the measurement system during maintenance, and a potentiostat (3) electrically connected to the flow cell.

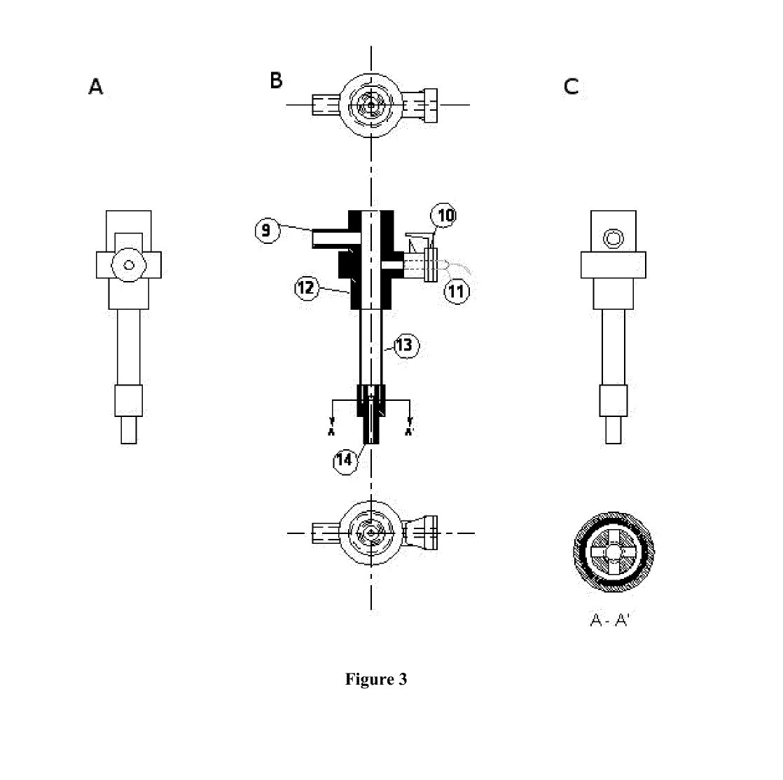

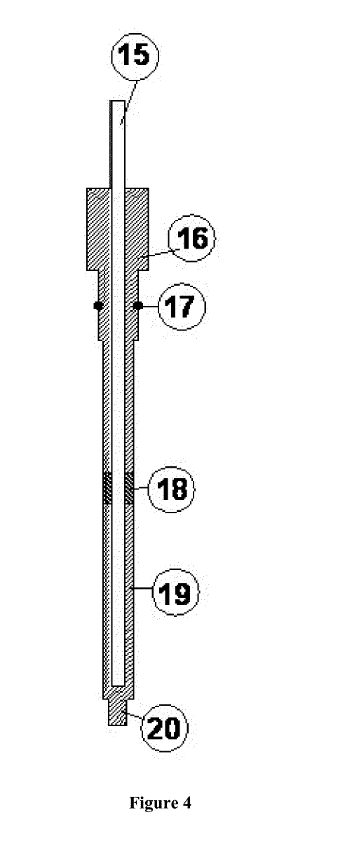

The parts of the flow cell (1) are shown in FIG. 2 and are, an external body (7) and a central axis (8) both illustrated in FIGS. 3 and 4 respectively.

The body (7) is constituted by an outlet connection fitting (9), a fast coupling fitting (10) which serves to connect a reference electrode (11), a head (12), a tubular counter electrode (13) and a feed connection fitting (14). The counter electrode (13) is solidary to the head (12) and to the feed connection fitting (14), and the outlet connection fitting (9) is solidary to the head (12) as indicated in FIG. 3. In a preferred embodiment, all the previous elements, except the counter electrode, are made of a high resistance, non-conducting plastic.

The central axis (8) is constituted by an electrical connection stem (15), a top support (16), a leak proof seal (17), an annular band for the working electrode (18), a bottom support (19) and a fixation pivot (20), all of these elements are solidary united as a single piece as indicated in FIG. 4.

The central axis (8) is inserted in the external body (7) through a sealed fast coupling (17).

### DETAILED DESCRIPTION OF THE INVENTION

The present invention is directed to a system (FIG. 1) to perform online electrochemical measurements with conducting solids, such as metals and minerals submerged in a specific electrolyte comprising: (1) an annular flow cell; (2) dosing pump; (3) potentiostat; (4) rotameter or flowmeter; (5) solution supply (process tank or pipe with solution); (6) electrolyte flow or circulation of flow and valves (V1) and (V2).

The flow cell has an internal volume between 5 and 50 ml and its inner geometry, wherein the electrolyte flows, is annular.

The electrolyte must have sufficient electrical conductivity to perform electrochemical measurements. The flow cell (1) which is an object of the present invention is fed with a stable electrolyte caudal to be considered in the measurement. For this effect, this is driven by a pump allowing a controlled regulation of flow so the measurements have a minimum noise; this is achieved with a centrifugal pump (2) preferably driven by a frequency variator which precisely controls de rotation speed of the rotor in order to maintain circulation of fluid (6) at a stable flow and with minimal turbulence. The pump (2) has a hydraulic height between 1 and 5 m of a water column, can resist corrosive fluids, and is monophasic or three-phase. The frequency of the variator must be adjusted to obtain a desired flow than can be measured with a flowmeter or rotameter (4). The liquid, fluid, electrolyte, electrolyte flow or solution comes from a supply (5) that can be a pipe or tank wherein the fluid circulated, passes through the flow cell, and returns to the supply. It is important that the fluid circulation circuit (6) has valves V1 and V2 at the inlet as well as the outlet of the flow cell, made of a high mechanical resistance plastic, to stop the fluid supply in moments when maintenance is performed to the measurement system. For the electrochemical measurements, the flow cell is connected to a potentiostat (3) in the same conventional manner in which commercial electrochemical measurements cells are connected.

The parts of the flow cell (1) are the cell body (7) and the central axis of (8) the cell.

The cell body (7) is formed by a plastic fitting for connecting the solution outlet (9), a fast coupling fitting (10) for the reference electrode (11), a head (12), a counter electrode (13) of a noble metal, and a plastic fitting for connection to the feed supply (14). In a preferred embodiment the counter electrode (13) is made of stainless steel, for example, but not limited to 316L or similar with high corrosion resistance. All plastic parts must have mechanical resistance to resist handling, be electrically isolating, inert to environmental conditions and chemically stable. In a preferred embodiment all the previous elements, except for the counter electrode, all are made of high resistance, non-conducting plastic. In a preferred embodiment the plastic parts are, for example, but not limited to PVC, Teflon, or similar.

The central cell axis (8), the reference electrode (11) and the counter electrode (13) are connected to a potentiostat (3).

Elements (12) and (14) are constructed in a precision lathe with measures assuring waterproof seal of the parts (9), (10) y (13). In particular, the fast coupling fitting (10) is chosen or fabricated according to the reference electrode (11) used. This fitting is fixed to the element (12) using an epoxy glue. It is important to emphasize that the active end of the reference electrode (11) must be leveled at the external surface of the annular conduct. All the set must be subjected to hydraulic tests before use, for which the use of a gas under pressure used with an external provision of a water/detergent mixture in order to detect leaks.

The central axis of the cell (8) illustrated in FIG. 4 is constituted by an electrical connection stem (15) made of corrosion resistant steel, for example, but not limited to, stainless steel 316 of a diameter no greater than 4 mm, top plastic support (16), waterproof seal using O rings (17), annular band for working electrode (18) and bottom plastic support comprising a fixing pivot (19) precisely inserted in the internal part of element (14) as shown in FIG. 2. All elements are manufactured in a precision lathe; in particular the central orifice of elements (16), (18), y (19) allowing insertion of the electrical connection stem (15) in a precise manner to avoid filtration of the solution and at the same time electrical connection between elements (15) and (18). The waterproof seal (17) can be one or two ring(s) of O ring type, the adjustment position together with the stem (20) fix the working electrode in a position concentric annular with respect to the concentric working electrode (13).

All the parts of the system, with the exception of the annular band (18) are made from a non-metallic, inert, non-corrosive material.

### Functioning of the Flow Cell.

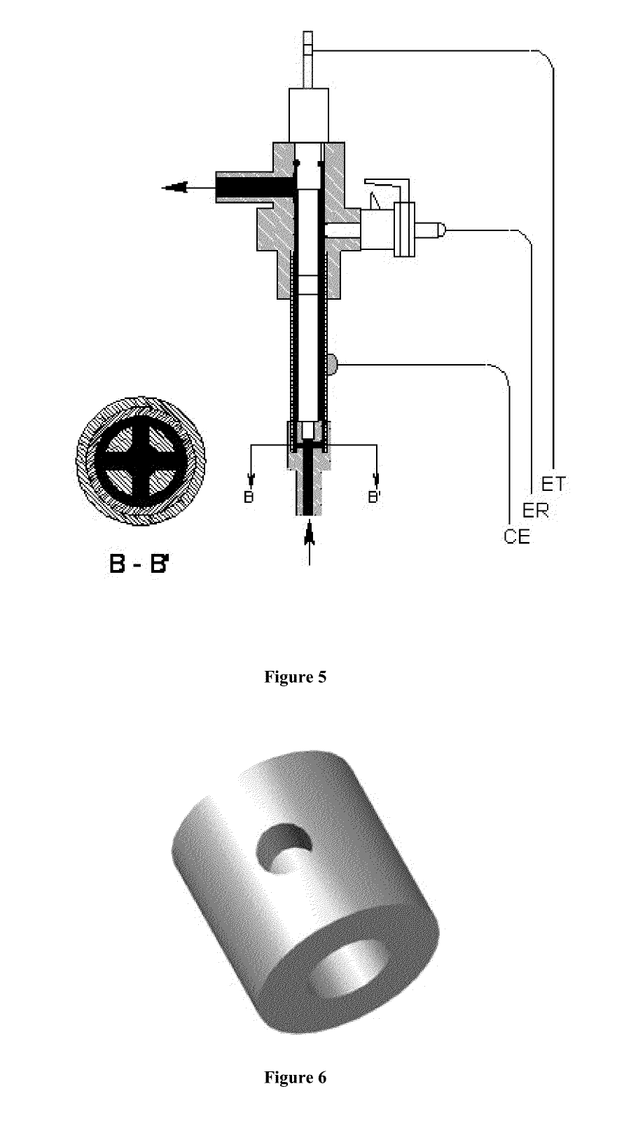

The cell is installed according to the scheme of FIG. 1. The central axis of the cell (8) is inserted in the body of the cell (7) such that the pivot (20) is adjusted to the internal central hole of element (14) observed in the cross-section A-A′ in FIG. 2. The internal parts of the cell emphasized in black in FIG. 5 are filled with solution during its functioning. The liquid driven by the pump (2) enters through the conduct of element (14) and is distributed through four radial holes indicated in cross-section B-B′ of FIG. 5. With this configuration is achieved on one side the central axis of the cell (8) is easily installed and with a concentric fixation, and on the other side that the fluid distribution in the annular space is homogeneous to minimize the zone in which turbulence occurs.

Once the fluid is in circulation, the pertinent electrochemical measurements are made. If in any moment, the working electrode is to be replaced, the pump must be stopped and both valves of the circuit V1 and V2 must be closed (FIG. 1).

The present invention presents clear advantages confronted with known systems since its flow cell design presents great versatility in terms of size, flow, fast replacement of working and reference electrodes, stability in measurements and with the alternative of use for powdered electro active solids, as the case of mineral concentrates.

### Examples of Application

### Steel Corrosion Measurement

There are numberless corrosive solutions used in industrial processes for which there is the need to perform corrosion assays with different purposes, such as: a) verifying effectiveness of corrosion inhibitors, b) verifying in a quick manner the corrosivity changes of a liquid in response to variability in its chemical composition, c) corrosion assays with different types of steel, etc.

In this application, the steel sample, which is component (18), is a ring or metallic band with a polished external surface with either sandpaper or other abrasive material. The component (18) is prepared in the shape of a ring and inserted in the central axis (8). The ring has precise dimensions to achieve that the central axis (8) construction does not carry visible cracks under a microscope. The final assembly is performed with a high quality glue that adheres to plastic surfaces as well as metallic surfaces at the same time that all types of micro-fissures are covered. The final polishing of the electrode before the assay starts with leveling the metal-plastic surface using a cutting tool lathe at very slow advance and then with water sandpaper of different grades. For long experiences, it is convenient to prepare various exchangeable electrodes, storing them in an hermetic container with a humidity adsorbent, such as silica gel.

### Measurement of Equilibrium Potential in Flotation Processes.

If the mineral sample is formed by massive solids, the sample can be prepared in the same manner that a metal described in the preceding section. Nevertheless, it is infrequent that the mineral is found in a massive form when preparing an electrode. The mineral is usually found in granular form and in these conditions, the only option is fixing the particles in a conducting medium for electrochemical assays. The granular form mineral must be ground to obtain a fine granulometry, the most uniform possible. The mineral prepared in this manner must be dispersed as a powder layer over a solid surface of a material denominated support for preparing a working electrode. This support material must have the following properties: i) being electrical conductor, ii) having a good electrochemical window in the potential range of interest, i.e. during a voltammetry sweep it will not generate electrochemical reactions, and if it does, these occur with a negligible conversion grade, and iii) good adherence to metals as well as solid particles for the latter to be retained forming a uniform layer. The retention grade of the particles must be such that they should not be released during handling. An alternative is the use of a mixture of wax-graphite, silicon or other conducting material over which a powder layer is deposited to prepare working electrodes for flow cells.

The working electrode for these applications is prepared without component (18), in order to leave a space in the shape of an annular band which is filled with a mixture of wax-graphite to form a continuous cylinder; this is performed with the mixture in a fusion state with a high viscosity paste consistency. The final termination of the wax-graphite annular surface can be performed by sliding a scraper on the periphery of the cylinder or also by using a lathe. In the exposed surface of the wax, a mineral powder, with predetermined particle size, layer is deposited. To this end, the electrode is rotated on the wax-graphite band side over a flat powdered surface. It is important that the formed layer is homogeneously distributed. This is not easy to achieve, and therefore an alternative to prepare this electrode is by using a plastic ring with a radial hole with a diameter no greater than the axial hole, which is filled with a wax-graphite mixture and later on with a powder layer. This ring is illustrated in FIG. 6 and must have one or more holes of 2.5 mm diameter in the center of the ring, taking care that the hole reaches the stem (15). Once the central axis (7) is assembled, the hole is filled with the wax-graphite mixture. The wax surface must take a curved shape, proper of the electrode cylinder, before proceeding to fix the powder layer. Once the set is polished, the wax-graphite surface which is now a small circle, is easy to cover with a particle layer.

### EXAMPLES

The following examples show features and properties of the invention that can be applied to corrosion metals, exposed to a solution of 0.1 M NaCl in different conditions. Nevertheless, these examples do not limit the invention.

The Examples described below are compared with values obtained using a conventional rotating electrode.

### Example 1

### Measurement of Polarization Curves for Carbon Steel

The specimen is a polished ring over which axially flows distilled water with 0.5M NaCl with aeration.

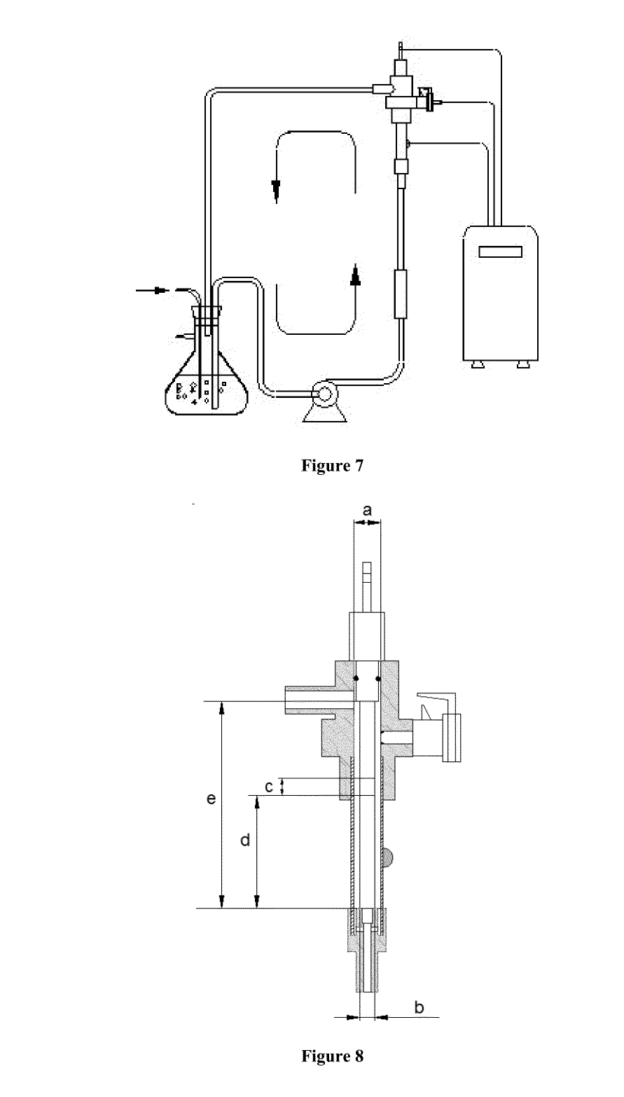

The experimental scheme used is similar to the one shown in FIG. 1, with the observation that the electrolyte supply is a 2 L flask which is permanently bubbled with air to maintain a fixed oxygen concentration (FIG. 7). The dimensions are relevant for the flow cell used, and are indicated in FIG. 8, wherein in this example are: a) top insertion support diameter (16) is 20 mm, b) diameter of inlet (14) and outlet (19) connections is 10 mm, c) the length of the specimen (18) is 17 mm, d) the length between the end and the specimen (18) in the central axis (8) is 190 mm and e) the length of the central axis (8) which is wetted with the electrolyte is 300 mm. The reference electrode was Ag/AgCl (sat) and the counter electrode was stainless steel 316L. The flow of solution through the flow cell was 90 L/h which is equivalent to Re=1200.

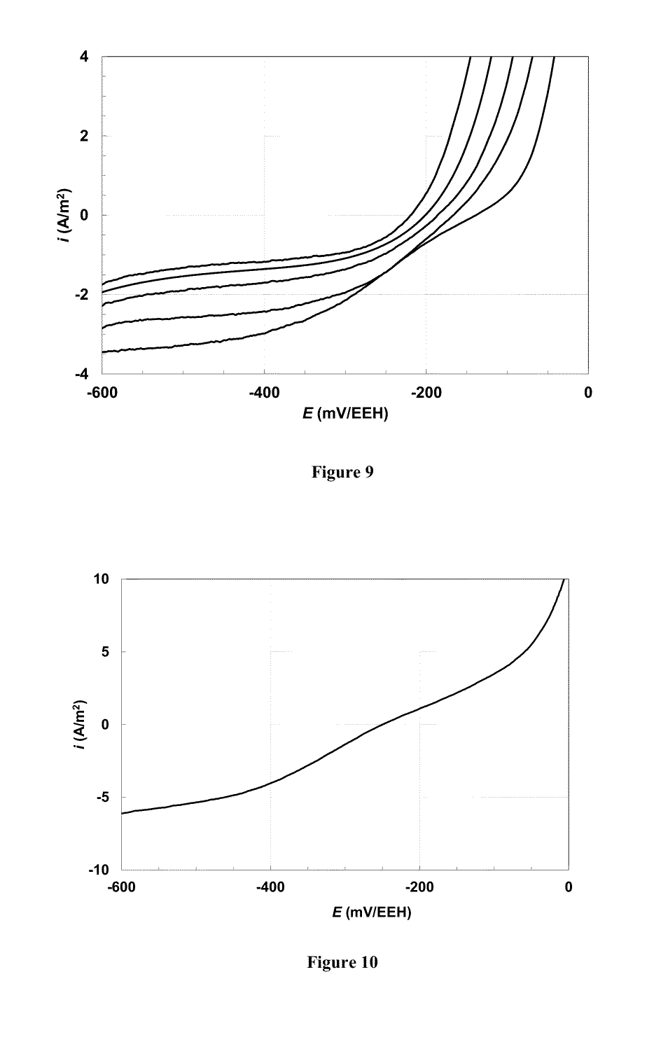

FIG. 9 shows the polarization curves obtained by linear sweep voltammetry measured with the annular cell with carbon steel in a solution of NaCl 0.1M with a potential sweep rate of 2 mV/s. The lower curve was obtained immediately after introducing the central axis with specimen. The measurement was repeated every half hour producing each time curves displaced upwardly. The Re value for this measurement was 1200.

FIG. 10 shows the comparison of polarization curves obtained using linear sweep voltammetry with a rotating disc electrode with carbon steel in a solution of NaCl 0.1M with a sweep potential rate of 2 mV/s. The electrolyte was confined in a deposit. Re value for this measurement was 1500.

Comments about these measurements:
Five measurements were performed, each every half hour during a lapse of 2.5 hours at a potential sweep rate of 2 mV/s.
The initial polarization curve (lower one) presents a shape that matches the measurements obtained with a conventional rotating disc cell (FIG. 10).
Upward displacement of each measurement is due to the gradual growth of oxide layer formed on the surface of the metal.
Any type of measurements can be made with a flow cell, since the electrolyte is constantly renovated.

### Example 2

### Measurements of Polarization Curves for Carbon Steel with a Flow Cell Smaller than the One from Example 1

The reference electrode was Ag/AgCl (sat) and the counter electrode of stainless steel 316L. The relevant dimensions of the flow cell are indicated in FIG. 8, and in this example are: a) top insertion support diameter (16) is 10 mm, b) diameter of inlet (14) and outlet (19) connections is 6.5 mm, c) the length of the specimen (18) is 10 mm, d) the length between the end and the specimen (18) in the central axis (8) is 30 mm and e) the length of the central axis (8) which is wetted with the electrolyte is 65 mm. The specimen is a polished ring over which distilled water with 0.5M NaCl axially flows. The experimental device is the one shown in FIG. 7.

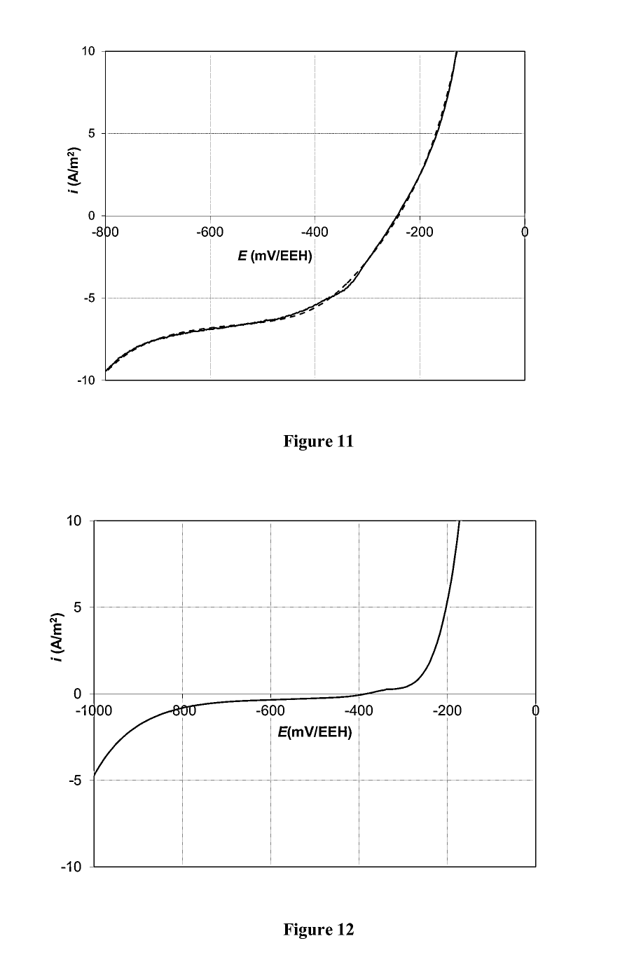

Two measurements were made, one with air and one with nitrogen. Both measurements are shown in FIGS. 11 and 12.

During measurement with air, bubbling was maintained at a temperature of 20° C.

FIG. 11 shows the polarization curve for measuring with air obtained by linear sweep voltammetry measured in a flow cell with carbon steel in a solution of NaCl 0.1M with a sweep potential rate of 2 mV/s. Re value for this measurement was 5000 (flow 210 L/h). The curve in dotted line is a mathematical fitting with a model to determine electrochemical parameters.

FIG. 12 shows polarization curve for measurement in anaerobic conditions (nitrogen bubbling) obtained by linear sweep voltammetry measured with annular cell with carbon steel in solution of NaCl 0.1M with a sweep potential rate of 2 mV/s. Re value for this measurement was 5000 (flow 210 L/h).

The quality of the results of the curve in FIG. 11 was corroborated using an electrochemical parameter calculus software used in publication by L. Caceres, T. Vargas, M. Parra, “Study of the variational patterns for corrosion kinetics of carbon steel as a function of dissolved oxygen and NaCl concentration”, Electrochemical Acta 54 (2009) 7435-7443). The results are shown in Table 1.

TABLE 1
Electrochemical corrosion parameters for carbon steel AISI 1020
in an aerated 0.5M NaCl solution, through an annular conduct.
Data is compared to those obtained using a conventional
rotary disc obtained from prior art.

| | | | Example 3 | |
|---|---|---|---|---|
| | Cell | | Annular | Rotary |
| | Re | | 5000 | 1300 |
| Oxygen | i_{0O2} | A/m² | 0.000048 | 0.000013 |
| | t_{O2} | mV/dec | 206 | 199 |
| | iₗ | A/m² | −6.5 | −9.3 |
| Iron | i_{0Fe} | A/m² | 0.0150 | 0.0024 |
| | t_{Fe} | mV/dec | 169 | 138 |
| Hydrogen | i_{0H2} | A/m² | −0.0000022 | −0.025 |
| | t_{H2} | mV/dec | −200 | −200 |
| | E_{corr} | mV/dec | −241 | −242 |
| | i_{corr} | A/m² | 2.3 | 4 |

EEH: Standard hydrogen electrode,
Re: Reynolds number, i_{0O2}, i_{0Fe}, i_{0H2} are exchange streams for oxygen, iron, and hydrogen respectively,, t_{O2}, t_{Fe} y t_{H2}, are Tafel slopes, iₗ is the limit stream for oxygen, E_{corr}, is the corrosion potential referred to the standard hydrogen potential, and i_{corr} is corrosion stream.

Comments:
Measurement of the polarization curve under aerobic conditions provides corrosion parameters greatly similar to bibliographical data obtained by using rotary disc electrode. This is corroborated with the high quality fitting between a theoretical and experimental curves. The difference is the limiting current which is higher in rotary discs under similar conditions of Re number.
The measurement of the polarization curve under anaerobic conditions (nitrogen bubbling) shows a loss of the plateau characteristic of oxygen reduction in the cathode branch, which is absolutely expected.
It is then concluded that the electrochemical measurements with the cell of the present invention are trustworthy.

### Example 3

### Measurement of Polarization Curves of a Copper Mineral in Contact with an Aqueous Solution of 0.5 M NaCl

A central axis with a small hole as indicated in FIG. 6 was used. The hole was filled with a steel-graphite mixture. Two measurements with wax-graphite were made, one with aeriated electrolyte and one with nitrogen bubbling and finally a wax-graphite measurement and a mineral layer adhered under nitrogen bubbling. The reference electrode was Ag/AgCl (sat) and the counter electrode of stainless steel 316L.

The wax-graphite mixture was made with wax from household candles and graphite purchased from Aldrich S.A. denominated powder 282863 in a carbon:wax ratio of 1:1.3. This mixture has been used in rotary electrodes in various reports. The mixture in fusion state of approximately 60° C. with an appearance of viscous liquid, was introduced in the hole of the annular band (18) that is part of the central axis (8) as indicated in FIG. 4. When cooled down to room temperature, has the property of retaining solid particles by adhesion.

To verify the correct working of this mixture, a polarization curve measurement was performed, with a sweep at 2 mV/s.

A mineral sample in form of powder with granulometry between 40 and 200 microns and a composition of 40% Cu, 18% Fe and other components was spread over a small glass surface and using manual pressure a layer was placed over the wax-graphite surface. This operation was very fast producing a very uniformly adhered layer.

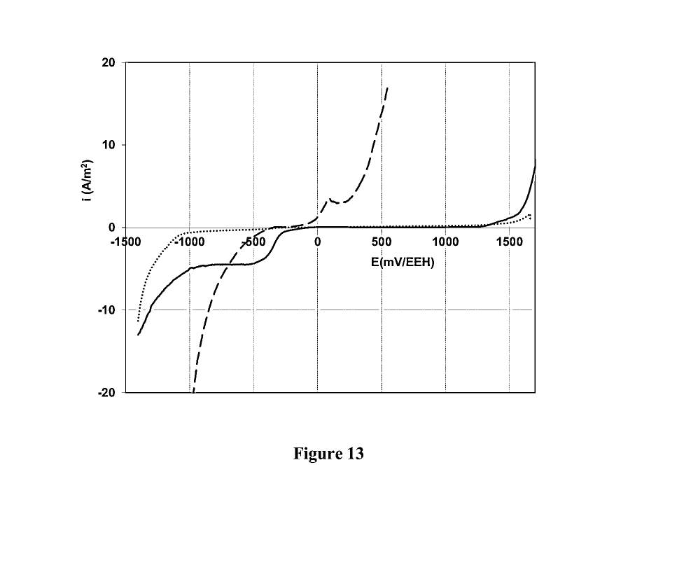

With the mineral electrode, polarization curves shown in FIG. 13 were measured.

FIG. 13 shows the polarization curves obtained for the measurements through linear sweep voltammetry at a velocity of 2 mV/s for the wax-graphite electrode in 0.5M NaCl aerated in a flow cell of Example 3. The dotted line was obtained from wax-graphite electrode in 0.5M NaCl with nitrogen bubbling. The dashed line was obtained from the wax-graphite-mineral electrode.

Comments:
The plateau shown in the curve for wax-graphite in the cathode branch corresponds to reduction of dissolved oxygen in the electrolyte. This is shown in the dotted line which was obtained when displacing the oxygen with nitrogen.
This demonstrates that in presence of electrolytes lacking dissolved oxygen, the wax-graphite electrode shows an electrochemical window limited for the evolution of hydrogen in the cathode branch and oxygen evolution in the anode branch.
In consideration of this, the curve for wax-graphite-mineral reflects only the electrochemical interaction of the mineral with the electrolyte.
Thus, it is concluded that the electrode prepared in this manner is simple and effective to perform electrochemical measurements in form of powder to be used in the flow cell of the present invention.

1. A system for performing online electrochemical measurements with solid conductors immersed in a specific electrolyte, wherein the system comprises:
(1) an annular flow cell;
(2) a dosing pump;
(3) a potentiostat;
(4) a rotameter or flowmeter;
(5) a solution supply (process tank or pipe with solution); and
(6) an electrolyte flow or fluid circulation and valves (V1) and (V2).

2. The system according to claim 1, wherein the annular flow cell has an internal volume between 5 and 500 ml and its internal geometry, through which the electrolyte circulates, is annular.

3. (canceled)

4. (canceled)

5. The system according to claim 1, wherein the pump is a centrifugal pump driven by a frequency variator which controls the rotation velocity of the rotor to maintain fluid circulation at a stable flow and with minimal turbulence.

6-9. (canceled)

10. The system according to claim 1, wherein the flow cell is connected to a potentiostat for electrochemical measurements.

11. (canceled)

12. The system according to claim 1, wherein the flow cell comprises a cell body and a central axis, and wherein the cell body is formed by a connection plastic fitting at the solution outlet, a fast coupling fitting for reference electrode, a head, a counter electrode made of a noble metal, and a connection plastic fitting to the solution feed.

13. The system for performing online electrochemical measurements with solid conductors such as metals and minerals immersed in a specific electrolyte according to claim 12, wherein the counter electrode is made of a material selected from platinum and stainless steel.

14-18. (canceled)

19. The system according to claim 12, wherein the central axis of the flow cell, the reference electrode, and the counter electrode are connected to a potentiostat.

20. (canceled)

21. The system according to claim 12, wherein the fast coupling fitting is chosen or fabricated according to the reference electrode used.

22. (canceled)

23. The system according to claim 12, wherein the reference electrode (11) end is leveled to the external surface of the annular conduct.

24. The system according to claim 1, wherein the central axis of the flow cell is aligned with an electrical connection stem, a top plastic support, a waterproof seal through O ring, an annular band for the working electrode and a plastic bottom support which has a fixation pivot inserted in the internal part of the connection plastic fitting to the solution feed.

25. The system according to claim 1, wherein the electrical connection stem is comprised of corrosion resistant steel.

26-28. (canceled)

29. The system according to claim 24, wherein the hermetic seal comprises one or two adjustment ring(s) or O ring.

30. The system according to claim 29, wherein the position of the hermetic seal together with the stem fix the working electrode in a concentric annular position to the concentric working electrode.

31. (canceled)

32. (canceled)

33. The system according to claim 1, wherein the system is suitable for measuring steel corrosion.

34. The system according to claim 33, wherein the annular band for the working electrode is a ring or metallic band with a polished external surface.

35. The system according to claim 34, wherein the annular band for the working electrode is prepared in the shape of a ring to be inserted in the central axis.

36-38. (canceled)

39. The system according to claim 1, wherein the system is suitable for measuring equilibrium potentials in flotation processes.

40. The system according to claim 39, wherein the solid conductor is a mineral in granular form comprising particles that are fixed in a conducting medium for electrochemical assays.

41. (canceled)

42. The system according to claim 40, wherein the mineral in granular form is dispersed as a powder layer over a solid surface of a support material for preparing a working electrode.

43. (canceled)

44. The system according to claim 43, wherein the support material comprises a mixture of wax-graphite, silicon, or other conducting material over which the powder layer is deposited to prepare working electrodes in flow cells.

45-52. (canceled)
